(19) United States
(12) Patent Application Publication
(10) Pub. No.: US 2004/0032888 A1
(43) Pub. Date: Feb. 19, 2004

(54) Laser module comprising a drive circuit

(76) Inventor: Christian Ferstl, Neutraubling (DE)

Correspondence Address: COHEN, PONTANI, LIEBERMAN & PAVANE, 551 FIFTH AVENUE, SUITE 1210, NEW YORK, NY, 10176, US

(21) Appl. No.: 10/362,405

(22) PCT Filed: Aug. 14, 2001
(86) PCT No.: PCT/DE01/03108

(30) Foreign Application Priority Data
Aug. 22, 2000 (DE) 10041079.0

(51) Int. Cl. H01S 3/00

(52) U.S. Cl. 372/38.02

(57) ABSTRACT

The invention describes a laser module (1) with a semiconductor laser (2) and a drive circuit. The drive circuit has an energy storage means (4) and an electronic switch (3), and the semiconductor laser (2) is connected to the energy storage means (4) via the electronic switch (3).

The invention relates to a laser module with a drive circuit as generically defined by the preamble to claim 1.

A laser module with a drive circuit is known for instance from U.S. Pat. No. 5,422,900. This reference shows a laser module which has a laser diode and a printed circuit board in the same housing. A drive circuit for the laser diode is applied in the form of an integrated circuit to the printed circuit board. The laser module described is used to generate nanosecond laser pulses.

Power semiconductor lasers with a high output power require high current intensities, which are typically in the ampere range, during operation. Direct triggering with an integrated circuit, of the kind shown in U.S. Pat. No. 5,422,900, is therefore not possible as a rule.

In generating nanosecond laser pulses with power laser diodes, a complicated electrical power supply is also necessary. This power supply must be capable of impressing the requisite operating current into the laser diode within the switching time, which is only a few nanoseconds.

Furthermore, generating nanosecond laser pulses requires short line lengths and thus a tightly packed arrangement of the current source and laser diode. Short line lengths are required to avoid a prolongation of the laser pulses as a consequence of signal transit times.

The object of the invention is to create a laser module which is suitable for generating nanosecond laser pulses of high intensity. In particular, it should be possible to operate the laser module using a technologically simple current source.

This object is attained by a laser module as defined by claim 1. Advantageous refinements of the invention are the subject of the dependent claims.

According to the invention, it is provided that to form the laser module with a semiconductor laser and a drive circuit, in which the drive circuit includes an energy storage means and an electronic switch, and the semiconductor laser is connected to the energy storage means via the electronic switch.

A semiconductor laser is understood to be a unit which contains at least one laser diode. The semiconductor laser may contain a single semiconductor body of a laser diode, or a plurality of such semiconductor bodies interconnected with one another, or one or more laser diodes as a component.

The semiconductor body or semiconductor bodies can have either a single active layer or a plurality of active layers, for instance in the form of a stack or bar. The semiconductor body or semiconductor bodies can also be formed of a plurality of individual semiconductor bodies joined together to make a stack or bar.

The energy storage means is a unit for storing electrical energy. The electrical energy is preferably stored in an electrical field in the manner of a capacitor. Other forms of stored energy are also possible, for instance in the form of chemical energy in the case of an energy storage means on the order of a rechargeable battery.

The semiconductor laser is supplied with operating current from the energy storage means when the electronic switch is closed. If the electronic switch is clocked with electrical pulses, the semiconductor laser emits laser pulses with a pulse duration that essentially matches the duration of the clock pulses.

Since in the invention the energy storage means and the semiconductor laser are combined in a module, a tightly packed arrangement and an electrical connection with short line lengths are both assured.

The signal transit time is advantageously thus kept slight. It is easily possible to generate nanosecond laser pulses by triggering the electronic switch with nanosecond clock pulses. The term nanosecond laser pulses is understood in particular to mean pulses with a pulse duration of less than 100 ns, and preferably less than 20 ns.

Another advantage of the invention is that because of the energy storage means contained in the laser module, the requirements for an external power supply are made less stringent.

In the generation of nanosecond laser pulses, the energy storage means is loaded only briefly, and so a capacitor, or a circuit based on one or more capacitors, suffices as an energy storage means for supplying the semiconductor laser. This makes an economical, compact structure of the laser module possible.

The laser module preferably has a supply terminal, by way of which the energy storage means is supplied with energy. This compensates for the consumption of energy caused by the semiconductor laser, so that advantageously a steady-state or quasi-steady-state operation of the laser module is possible.

A direct connection between the energy storage means and the supply terminal is especially preferred. If in operation the supply terminal is connected to an external current source, the energy storage means is continuously recharged.

In the case of continuous recharging of the energy storage means, the external current source is advantageously loaded only with the average input power of the laser module, while the energy storage means meets the time-critical peak power demand that occurs during the switching times, when the semiconductor laser is in operation.

This continuous supply is especially advantageous when the duty cycle of the laser pulse train generated is low. In that case, the external current source, in accordance with the duty cycle, is loaded with only a slight continuous duty.

The invention preferably has a control terminal that is extended out of the laser module and with which the electronic switch is controlled. This makes flexible, direct control of the emitted laser pulses possible.

Alternatively, the drive circuit contained in the laser module can be expanded with a clock generator that controls the electronic switch. The laser module embodied in this way advantageously requires no further triggering for the pulsed operating mode.

In an advantageous refinement of the invention, the electronic switch is embodied in two stages. The second stage (switching stage) acts as the actual switch, while the first stage (input stage) serves as a driver for the second stage.

The division of the switch into two parts offers the advantage that the second stage is optimized for switching a high-current load, of the kind represented by a semiconductor laser with high output power. The input characteristic of the electronic switch is defined largely independently of this by the input stage.

In addition, this division into two parts makes it possible to use commercially available switches and drivers in the switching and input stages, respectively.

A power MOSFET is preferably used as the switching stage. Power MOSFETs are especially well suited for switching high currents, so that with them, a laser module that switches reliably can be realized.

Also advantageously, a MOSFET driver with a high-impedance and a correspondingly low power consumption at the input is used as the input stage. Such drivers are likewise commercially available, for instance in the form of an integrated circuit, so that in this way, at little effort or expense, a laser module that can be triggered virtually powerlessly can be created.

It is especially advantageous in this respect to use an input stage with a TTL input. This is understood to mean an input with an expanded input voltage range, which can be triggered with a TTL signal. A laser module embodied in this way can be connected directly to existing circuits with a TTL output and requires neither a separate driver in the existing circuit nor particular regulation of the supply voltage. Furthermore, the input stage can advantageously also be adapted to the signal levels of other logic families.

In a preferred embodiment of the invention, the semiconductor laser, electronic switch and energy storage means are mounted on a common substrate and connected via conductor tracks that are applied to the substrate.

A laser module embodied in this way is distinguished by being highly compact and having particularly short connections between the individual components. Because of the attendant short signal transit times, such a module is especially well suited for generating laser pulses with a duration of only a few nanoseconds.

Moreover, known techniques for producing substrates and conductor tracks and for mounting the individual components can be employed. This advantageously makes economical production of the laser module possible.

The invention is preferably used to generate nanosecond laser pulses of high peak power.

The invention is thus suitable, for instance, as a transducer in optical distance measuring devices.

Because of the low power consumption, the only slight demands in terms of power supply, and the simple and virtually powerless triggering, the use of the invention is especially attractive in mobile systems, especially in the automotive field and in aircraft construction.

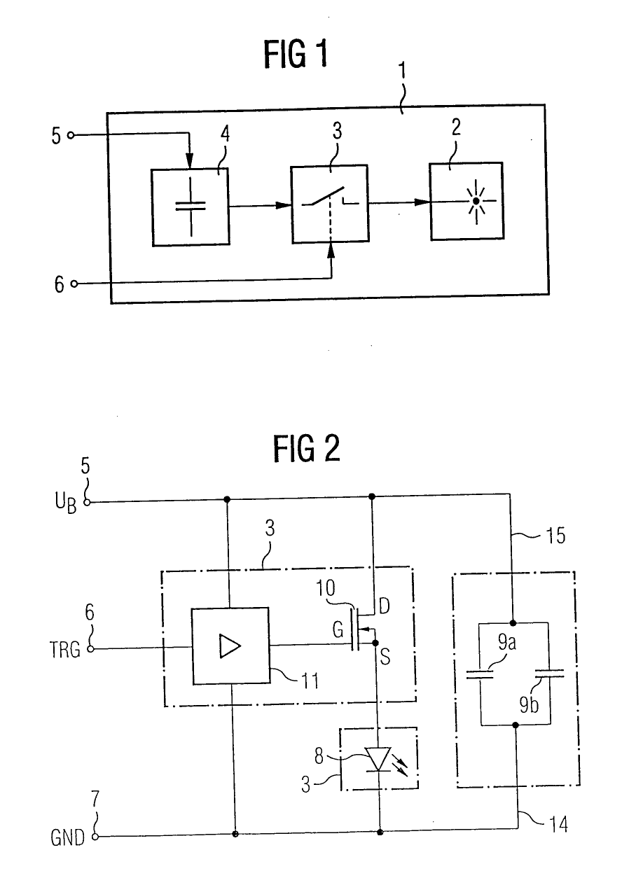

Further characteristics, advantages, and expedient features of the invention will become apparent from the ensuing description of three exemplary embodiments, in conjunction with FIGS. 1-4.

Shown are

FIG. 1, a block circuit diagram of a first exemplary embodiment of a laser module of the invention;

FIG. 2, a block circuit diagram of a second exemplary embodiment of a laser module of the invention;

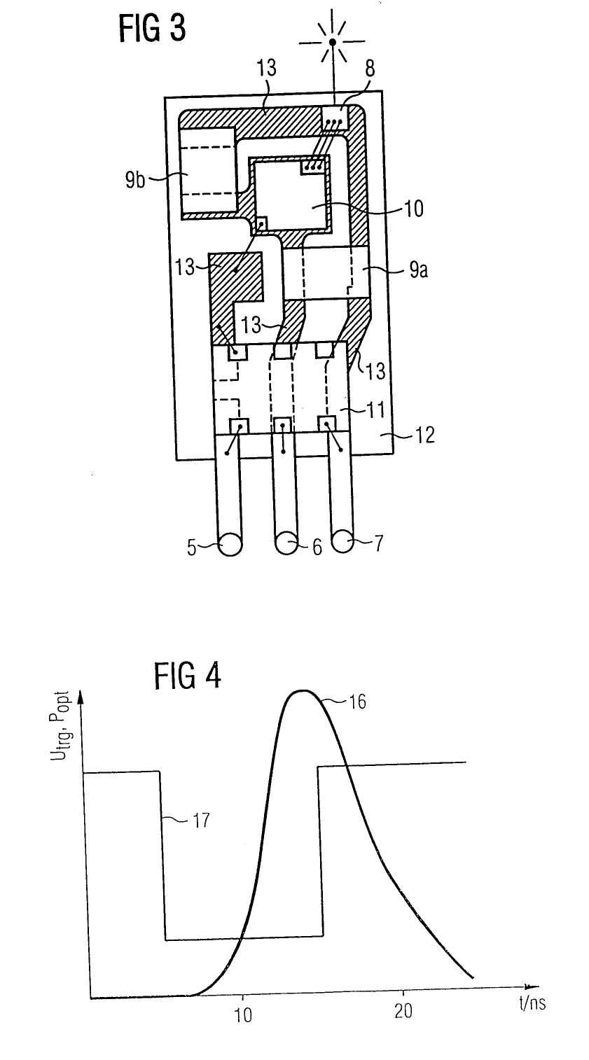

FIG. 3, a block circuit diagram of a third exemplary embodiment of a laser module of the invention; and

FIG. 4, the optical power, as a function of time, of a characteristic laser pulse generated by a laser module of the invention.

Elements that are identical or function the same are identified by the same reference numerals.

FIG. 1 shows a block circuit diagram of a first exemplary embodiment. The laser module 1 includes a semiconductor laser 2, an electronic switch 3, and an energy storage means 4.

Power laser diodes on the basis of GaAs are especially suitable as the semiconductor laser 2. The advantages of the invention, in particular the lower power consumption, are achieved especially with laser diodes that are designed for pulsed operation in the nanosecond range. With such laser diodes, because of the brief pulse duration, a high peak intensity is achieved. The power consumption of the laser module can be kept low by triggering with a low duty cycle.

The energy storage means 4, which is connected to the semiconductor laser via the electronic switch 3, serves to supply power to the semiconductor laser 2.

The energy storage means 4 has an external terminal 5, by way of which the energy storage means 4 is charged. At little effort or expense, the energy storage means 4 can be realized by a capacitor or a by a plurality of capacitors connected in parallel. Depending on the application, energy storage means that have a higher capacity, such as rechargeable batteries, can be used. The energy storage means can also be embodied in multiple stages, for instance in order to cover the peak power demand of the semiconductor laser separately.

The electronic switch 3 that connects the energy storage means 4 to the semiconductor laser 2 is triggered via the control terminal 6. In the closed state of the electronic switch 3, the semiconductor laser 2 is connected to the energy storage means 4, so that the energy storage means 4 discharges via the semiconductor laser 2.

As the switching stage of the electronic switch 3, power MOSFETs are preferably used, which because of their thermal properties are especially well suited to high-current loads, of the kind that semiconductor lasers with a high output power represent.

In high-frequency triggering of a MOSFET of this kind, however, the control current rises because of the fast charge reversal of the MOSFET gate capacitance. It is therefore advantageous for the MOSFET switching stage to be triggered via its own driver, so that the electrical properties of the control input 6 are largely independent of the MOSFET switching stage.

The MOSFET switching stage can especially thus be preceded by a high-impedance input, which even in the high-frequency range makes virtually currentless or powerless triggering possible.

FIG. 2 shows the circuit diagram of a second exemplary embodiment. A GaAs laser diode 8 with an InAlGaAs/GaAs-QW structure is used as the semiconductor laser 3. The laser diode has a peak power of approximately 20 W and an emission wavelength of 905 nm.

Serving as the energy storage means 4 is a parallel circuit of two capacitors 9a and 9b. One terminal 14 of the parallel capacitor circuit is, like the cathode of the laser diode 8, connected to the reference potential terminal 7, while the other terminal 15 is connected to the supply voltage terminal 5.

Via the supply voltage terminal 5, the parallel capacitor circuit is continuously recharged and kept at the potential of the supply voltage.

This terminal 15 is also connected, via the power MOSFET 10, to the anode terminal of the laser diode 8, and the drain terminal of the MOSFET 10 is connected to the terminal 15 of the parallel capacitor circuit, and the source terminal is connected to the anode of the laser diode 8. The gate of the MOSFET is triggered by the control terminal 6, via the MOSFET driver 11. A high-speed CMOS driver with a TTL input is used as the MOSFET driver 11.

The laser module can thus be controlled with a TTL signal, virtually in currentless or powerless fashion. The laser module can therefore advantageously be integrated into existing TTL circuits without additional effort or expense.

MOSFET drivers of the family EL7104C or EL7114C (Elantec Inc., data sheet 1994) with switching times of only a few nanoseconds are especially well suited as high-speed drivers.

For operation, the MOSFET driver 11 is connected to the supply terminal 5 and to the reference potential terminal 7. It would be possible without any problem to separate the supply voltages for the driver 11 and the energy storage means 4 by means of an additional terminal extended to the outside, if that is wanted, for instance because of the different power demand or different operating voltages of the driver 11 and energy storage means 4.

The embodiment shown in turn allows a very compact laser module, which can be operated with a single current source.

In operation, upon an active control signal at the control terminal 6, the driver 11 switches the MOSFET 10 to be conducting. As long as the control terminal is activated, the capacitors 9a, 9b are discharged via the laser diode 8. Accordingly, the laser diode 8 emits a laser pulse.

FIG. 3 shows a plan view on a further exemplary embodiment of the invention. The individual components (laser diode 8, capacitors 9a, 9b, MOSFET 10, MOSFET driver 11) are mounted on a substrate 12 and are interconnected via conductor tracks 13 and wire connections, as shown in the circuit diagram of FIG. 2.

The integrated driver circuit 11 and the MOSFET 10 are glued to the substrate 12, and the various connection faces are connected to the corresponding conductor tracks 13 via wire connections.

As the capacitors 9a, 9b, SMD capacitors are used, which are soldered directly by their contact faces to the conductor tracks 13.

The supply terminal 5, reference potential terminal 7, and control terminal 6 are extended as a wire terminal to the outside of the laser module 1.

For the protection of the individual components, the entire module is potted or spray-coated with a housing molding composition. For this, a molding composition that is transparent to the laser radiation generated is preferably used. Alternatively, the emission surface of the laser diode 8 can be kept free of the molding composition.

The dimensions of the module are approximately 8 mm×5 mm, with a thickness of approximately 3 mm. Thus a very compact laser module which is controllable virtually in currentless or powerless fashion and with an equally slight power consumption is available.

In FIG. 4, a characteristic laser pulse 16 emitted by the exemplary embodiment just described is shown along with the control pulse 17. The optical power POPT of the laser pulse 16 and the control voltage UTRG 17 are plotted over time t.

As the control pulse 17, a square wave pulse with steep sides and with a pulse duration of 10 nanoseconds is used. The laser pulse 16 generated is virtually Gaussian, with a somewhat delayed trailing edge, and it has a typical pulse duration of 6 nanoseconds (full half-value width). The leading edge of the laser pulse 16 is delayed by approximately 5 nanoseconds compared to the leading edge of the control pulse 17, because of the rise time of the MOSFET driver 11 and of the MOSFET 10.

It is understood that the explanation of the invention in terms of the three exemplary embodiments described is not to be understood as a limitation of the invention.

1. A laser module (1) having at least one semiconductor laser (2) and one drive circuit,
characterized in that
the drive circuit includes an energy storage means (4) and an electronic switch (3), and the semiconductor laser (2) is connected to the energy storage means (4) via the electronic switch (3).

2. The laser module (1) of claim 1,
characterized in that
the semiconductor laser (2) has at least one laser diode (8) or one laser diode semiconductor body.

3. The laser module (1) of claim 1 or 2,
characterized in that
the energy storage means (4) includes at least one capacitor (9).

4. The laser module (1) of one of claims 1-3,
characterized in that
the laser module (1) has a supply terminal (5); and
that the energy storage means (4) is connected to the supply terminal (5).

5. The laser module (1) of claim 4,
characterized in that
the supply terminal (5) is connected directly to the energy storage means (4).

6. The laser module (1) of one of claims 1-5,
characterized in that
the laser module (1) has a control terminal (6) for controlling the electronic switch (3).

7. The laser module (1) of one of claims 1-6,
characterized in that
the electronic switch (3) has a first and a second stage, and the second stage acts as a power switch, which is triggered via the first stage.

8. The laser module (1) of claim 7,
characterized in that
the second stage is a power MOSFET (10).

9. The laser module (1) of claim 7 or 8,
characterized in that
the first stage is an integrated circuit (11) with a high-impedance input for triggering a power MOSFET (10).

10. The laser module (1) of one of claims 7, 8 or 9,
characterized in that
the first stage has a TTL input.

11. The laser module (1) of one of claims 1-10,
characterized in that
the energy storage means (4), the semiconductor laser (2), and the electronic switch (3) are applied to a common substrate (12).

12. The laser module (1) of claim 11,
characterized in that
conductor tracks (13) are embodied on the substrate (12), by which conductor tracks the energy storage means (4), semiconductor laser (2) and electronic switch (3) are connected.

13. The use of a laser module (1) of one of claims 1-12 for generating nanosecond laser pulses.

14. The use of a laser module (1) of one of claims 1-12 as a transducer in an optical distance meter.
